(19) United States
(12) Patent Application Publication
(10) Pub. No.: US 2014/0228199 A1
(43) Pub. Date: Aug. 14, 2014

(54) AMMONIA-PRODUCING CATALYST

(71) Applicants: National University Corporation Chiba University, Chiba-shi (JP); DENSO CORPORATION, Kariya-city (KR)

(72) Inventors: Masaki Yoshinaga, Nisshin-city (JP); Hiroaki Yotou, Nisshin-city (JP); Takumi Okamoto, Nisshin-city (JP); Miho Itoh, Nisshin-city (JP); Katsuyoshi Hoshino, Chiba-city (JP)

(73) Assignees: National University Corporation Chiba University, Chiba-shi (JP); DENSO CORPORATION, Kariya-city (JP)

(21) Appl. No.: 14/177,479

(22) Filed: Feb. 11, 2014

(30) Foreign Application Priority Data
Feb. 12, 2013 (JP) 2013-024714
Feb. 12, 2013 (JP) 2013-024715

(51) Int. Cl. B01J 31/38

(52) U.S. Cl. CPC B01J 31/38
USPC 502/1

(57) ABSTRACT

An ammonia-producing catalyst includes a p-type semiconductor, an n-type semiconductor, and a metal fine particle having a function of adsorbing nitrogen. In the ammonia-producing catalyst including the metal fine particle, generation of ammonia is promoted, and the generated amount of ammonia is increased. An ammonia-producing catalyst includes a p-type semiconductor, an n-type semiconductor, and an ammonia-fixing compound for fixing ammonia. In the ammonia-producing catalyst including the ammonia-fixing compound, a fixed yield of ammonia is sufficiently increased.

### CROSS REFERENCE TO RELATED APPLICATION

This application is based on Japanese Patent Applications No. 2013-24714 filed on Feb. 12, 2013 and No. 2013-24715 filed on Feb. 12, 2013, the disclosures of which are incorporated herein by reference.

### TECHNICAL FIELD

The present disclosure relates to an ammonia-producing catalyst.

### BACKGROUND

As an example of a method of synthesizing ammonia industrially, Haber-Bosch process was conventionally known. In the Haber-Bosch process, however, a fossil fuel is used as a raw material. Therefore, there is a problem of exhaustion of the resource. In addition, a reaction process needs to be carried out at a high temperature and a high pressure. Therefore, a large amount of energy is consumed. For these reasons, development of a method alternative to the Haber-Bosch process has been required.

For example, JP2008-221037A discloses a nitrogen-fixing material having a titanium oxide layer and a conductive polymer layer formed on the titanium oxide layer. The titanium oxide layer has a photocatalytic function. When the nitrogen-fixing material is irradiated with a light in the air in which nitrogen and moisture exist, the nitrogen in the air is fixed as an ammonium salt and thus ammonia is collected. Namely, ammonia can be produced using the nitrogen and the moisture in the air as the raw materials, in place of the fossil fuel, and using natural energy, such as sunlight.

Also, JP2012-055786A discloses a nitrogen-fixing material having a titanium oxide nano particle and a conductive polymer covering the titanium oxide nano particle. The titanium oxide nano particle has the photocatalytic function. In the nitrogen-fixing material of JP2012-055786A, the area of interface (contact area) between the titanium oxide and the conductive polymer, which provides a reaction point for generating ammonia, can be increased. Therefore, the production amount of ammonia is further increased, and the fixing yield is also improved.

### SUMMARY

When ammonia is produced using the nitrogen-fixing material disclosed in JP2008-221037A, JP2012-055786A or the like as an ammonia-producing catalyst, the problems of the raw material and the energy can be solved. However, it is still insufficient to increase the generation amount of ammonia. Further, the ammonia produced using such a nitrogen-fixing material is in a gas state at a normal temperature and a normal pressure. Therefore, it is difficult to sufficiently improve the fixing yield by the nitrogen-fixing material due to dissipation of the ammonia.

It is a first object of the present disclosure to provide an ammonia-producing catalyst which is capable of promoting generation of ammonia and sufficiently increasing the generation amount of the ammonia. It is a second object of the present disclosure to provide an ammonia-producing catalyst which is capable of improving a fixing yield of ammonia.

According to a first aspect of the present disclosure, an ammonia-producing catalyst includes a p-type semiconductor, an n-type semiconductor, and a metal fine particle having a function of adsorbing nitrogen.

The ammonia-producing catalyst includes the metal fine particle having the function of adsorbing nitrogen, in addition to the p-type semiconductor and the n-type semiconductor. Therefore, generation of ammonia is promoted, and thus the generation amount of ammonia can be sufficiently improved.

For example, when the ammonia-producing catalyst described above is irradiated with a light in an atmosphere in which nitrogen and moisture (in particular, hydrogen in the moisture) exist, the nitrogen is reduced at an interface between the n-type semiconductor having the photocatalytic function and the p-type semiconductor being in contact with the n-type semiconductor, and ammonia is generated.

The generation of ammonia is caused by a reaction of a decomposed material of nitrogen molecule and a decomposed material of water molecule. Decomposition of the nitrogen molecule and decomposition of the water molecule are caused by an electron, which exists on the surface of the n-type semiconductor, and a hole, which makes a pair with the electron. In order to efficiently promote the decomposition of the nitrogen molecule and the decomposition of the water molecule, the electron and the hole, which are in pair, are preferably in a state of being separated, that is, without being coupled. For example, when the p-type semiconductor is in contact with the n-type semiconductor, the separated state of the electron and the hole is kept. Thus, the decomposition of the nitrogen molecule and the decomposition of the water molecule are efficiently promoted, and thus the generation of ammonia is promoted.

The ammonia-producing catalyst described above has the metal fine particle having the function of adsorbing nitrogen, in addition to the p-type semiconductor and the n-type semiconductor. Therefore, it is possible to make the nitrogen to exist in the vicinity of the metal fine particle. For example, when the metal fine particle is arranged on the surface of the n-type semiconductor, that is, on the interface between the n-type semiconductor and the p-type semiconductor, which provides the reaction point for generating ammonia, the nitrogen can be existence in the vicinity of the electron that is separated from the hole and exists on the surface of the n-type semiconductor. For this reason, the decomposition of the nitrogen molecule and the decomposition of the water molecule can be further efficiently promoted, and thus the generation of ammonia can be further promoted. As a result, the generation amount of the ammonia can be sufficiently increased.

As described above, the ammonia-producing catalyst which is capable of promoting the generation of ammonia and sufficiently increasing the generation amount of ammonia can be provided.

According to a second aspect of the present disclosure, an ammonia-producing catalyst includes a p-type semiconductor, an n-type semiconductor, and an ammonia-fixing compound for fixing ammonia.

The ammonia-producing catalyst includes the ammonia-fixing compound, in addition to the p-type semiconductor and the n-type semiconductor. Therefore, the fixing yield of the ammonia can be sufficiently improved.

For example, when the ammonia-producing catalyst is irradiated with a light in an atmosphere where nitrogen and moisture (in particular, hydrogen in the moisture) exist, the nitrogen is reduced at the interface between the n-type semiconductor having the photocatalytic function and the n-type semiconductor being in contact with the n-type semiconductor, and thus ammonia is generated.

As described above, the generation of ammonia is caused by the reaction of the decomposed material of nitrogen molecule and the decomposed material of water molecule. Decomposition of the nitrogen molecule and decomposition of the water molecule are caused by an electron, which exists on the surface of the n-type semiconductor, and a hole, which makes a pair with the electron. In order to efficiently promote the decomposition of the nitrogen molecule and the decomposition of the water molecule, the electron and the hole, which are in pair, are preferably in a state of being separated, that is, without being coupled. For example, when the p-type semiconductor contacts the n-type semiconductor, the separated state of the electron and the hole is kept. Thus, the decomposition of the nitrogen molecule and the decomposition of the water molecule are efficiently promoted, and thus the generation of ammonia is promoted.

The ammonia is generated in the gas state at a normal temperature and at a normal pressure. The ammonia-producing catalyst described above includes the ammonia-fixing compound for fixing the ammonia, in addition to the p-type semiconductor and the n-type semiconductor. Therefore, the gas state ammonia generated at the interface between the p-type semiconductor and the n-type semiconductor can be fixed and collected as an ammonia compound being in a solid state by the ammonia-fixing compound, without dissipation. Accordingly, the fixing yield of the ammonia can be sufficiently improved.

As described above, the ammonia-producing catalyst, which can improve the fixing yield of the ammonia, can be provided.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a schematic diagram illustrating an ammonia-producing catalyst according to an example 1;

FIGS. 2A to 2C are diagrams for illustrating a manufacturing process of the ammonia-producing catalyst according to the example 1;

FIG. 3 is a diagram for illustrating a method of evaluation of the fixed amount of ammonia according to the example 1;

FIG. 4 is a bar graph illustrating the fixed amount of ammonia of each of samples S111 and S112 and a comparative sample C1 according to the example 1;

FIG. 5 is a bar graph illustrating the fixed amount of ammonia of each of samples S121 to S126 and the comparative sample C1 according to the example 1;

FIG. 6 is a bar graph illustrating the fixed amount of ammonia of each of samples S131 to S133 according to the example 1;

FIG. 7 is a bar graph illustrating the fixed amount of ammonia of each of samples S141 to S143 according to the example 1;

FIG. 8 is a bar graph illustrating the fixed amount of ammonia of each of samples S151 to S153 according to the example 1;

FIG. 9 is a bar graph illustrating the fixed amount of ammonia of each of samples S161 to S163 according to the example 1;

FIG. 10 is a schematic diagram of an ammonia-producing catalyst according to an example 2;

FIGS. 11A to 11C are diagrams for illustrating a manufacturing process of the ammonia-producing catalyst according to the example 2;

FIG. 12 is a bar graph illustrating the fixed amount of ammonia of each of samples S211 to S213 and a comparative sample C2 according to the example 2; and

FIG. 13 is a graph illustrating a relationship between a total amount of perchloric acid and the fixed amount of ammonia according to the example 2.

### DETAILED DESCRIPTION

Embodiments of the present disclosure will be hereinafter described.

In the present disclosure, a p-type semiconductor means a semiconductor in which a hole is used as a carrier for carrying an electric charge.

The p-type semiconductor is, for example, a conductive polymer. However, the p-type semiconductor is not limited to the conductive polymer. The conductive polymer is, for example, poly (3,4-ethylenedioxythiophene) (hereinafter also referred to as PEDOT), or the like. However, the conductive polymer is not limited to this example.

The n-type semiconductor means a semiconductor in which a free electron is used as a carrier for carrying an electric charge.

The n-type semiconductor is, for example, titanium oxide (TiO₂) that has a photocatalytic function, or the like. However, the n-type semiconductor is not limited to this example. In the case where the titanium oxide is used as the n-type semiconductor, the titanium oxide may be amorphous. Further, when the titanium oxide in a rutile form, an anatase form or a mixed form of rutile and anatase is used, the generation amount and the fixed yield of ammonia can be further increased, as compared to the amorphous titanium oxide.

In an embodiment of the present disclosure, an ammonia-producing catalyst includes an p-type semiconductor, an n-type semiconductor and a metal fine particle having a function of adsorbing nitrogen.

The metal fine particle having the function of adsorbing nitrogen means a metal fine particle having an electronic state density that allows transfer of electrons between a bonding orbital and an anti-bonding orbital of nitrogen gas. As the electrons transfer from a metal to the anti-bonding orbit of the nitrogen gas, dissociation of the nitrogen gas is promoted, and thus a reduction reaction by hydrogen following the dissocitation advances.

The ammonia-producing catalyst includes the n-type semiconductor and the p-type semiconductor covering the n-type semiconductor. For example, it is configured that a titanium oxide particle as the n-type semiconductor is covered with a conductive polymer as the p-type semiconductor. In this case, an area of interface (contact area) between the n-type semiconductor and the p-type semiconductor, which serves as a reaction point of generation of ammonia, can be effectively increased. Therefore, the generation of ammonia can be further promoted.

In the configuration described above, the titanium oxide particle is preferably a nanoparticle. In this case, the surface area of the titanium oxide particle is increased, and thus the area of interface (contact area) with the conductive polymer can be increased. As such, the generation of ammonia can be further promoted. In addition, the titanium oxide particle can be easily dispersed in the conductive polymer.

In such a case, the particle diameter (average particle diameter) of the titanium oxide particle is preferably 5 to 500 nm, and is more preferably 10 to 300 nm. The average particle diameter of the titanium oxide particle is, for example, obtained by a method of directly observing the particle using an electron microscope, such as a transmission electron microscope (TEM). Specifically, the average particle diameter can be provided by an average value of particle diameters measured at ten points.

The p-type semiconductor preferably contains an anion (counter anion) that bonds with an ammonium cation (NH₄⁺). Namely, when ammonia is changed into a solid-state ammonia compound, it becomes an ammonium cation (NH₄⁺) with positive charge. In order to form the solid-state compound from the ammonium cation, the ammonium cation needs to bond with an anion with negative charge. Therefore, when the anion (counter anion) with the negative charge exists in the p-type semiconductor, the ammonium cation with the positive charge and the anion with the negative charge easily form a salt. Accordingly, the fixed yield of ammonia can be improved.

As an example of the p-type semiconductor described above, the PEDOT containing a perchlorate ion (ClO₄⁻) may be used. In this case, ClO₄⁻ contained in the PEDOT desorbs by irradiation of a light, and bonds with H⁺ to become HClO₄. Further, this HClO₄ and ammonia (NH₃) generated by the irradiation of the light bond with each other, and deposits on the surface of the PEDOT as ammonium perchlorate (NH₄ClO₄). Accordingly, fixing and collecting of the ammonia are eased, and the fixed yield of ammonia increases.

The metal fine particle preferably exists in the state of being in contact with the n-type semiconductor. For example, the metal fine particle preferably exists on the surface of the n-type semiconductor. Namely, in the generation of ammonia, a reaction between the decomposed material of the nitrogen molecule and the decomposed material of the water molecule is progressed by using the electron existing on the surface of the n-type semiconductor. Therefore, at least the electron and the nitrogen are needed at the reaction point of generation of ammonia. When the metal fine particle having the nitrogen adsorption function is in existence in the vicinity of the n-type semiconductor on the surface of which the electron exists, the generation of ammonia is effectively promoted.

The metal fine particle having the nitrogen adsorption function can accept the electron existing on the surface of the n-type semiconductor. Therefore, when the metal fine particle is in contact with the n-type semiconductor, a separation state of the electron and the hole, which makes a pair with the electron, can be promoted. Further, the electron can be supplied to the nitrogen adsorbed on the metal fine particle having the nitrogen adsorption function. As such, the generation of ammonia can be further promoted.

For example, the metal fine particle is made of at least one or more selected from a group consisting of iron (Fe), rhodium (Rh), palladium (Pd), ruthenium (Ru), platinum (Pt), silver (Ag), nickel (Ni), copper (Cu), gold (Au), cobalt (Co), and iridium (Ir).

Namely, to reduce the nitrogen to ammonia, it is necessary to condense the nitrogen from the atmosphere using the nitrogen adsorption function of a transition metal. Moreover, to further reduce the adsorbed nitrogen to the ammonia, it is preferable to use a transition metal having a function of weakening of a triple bond of the nitrogen by supplying the electron to an anti-bonding orbital of the nitrogen, as the metal fine particle. In the case where the transition metal having such a function is used as the metal fine particle, the generation of ammonia can be further promoted.

For example, in regard to a molar ratio of the metal fine particle to the n-type semiconductor, the metal fine particle is 5 mol or less, when the n-type semiconductor is 100 mol. In other words, the molar ratio of the metal fine particle is 5 mol % or less of the n-type semiconductor.

In such a case, the metal fine particle can be further evenly dispersed in the catalyst. Therefore, the surface area of the metal fine particle can be increased. Moreover, the adsorption amount of nitrogen can be increased, and thus the generation of ammonia can be further promoted.

For example, the particle diameter of the metal fine particle is 5 nm or less.

In such a case, the metal fine particle can be further evenly dispersed in the catalyst. Therefore, the surface area of the metal fine particle can be increased. Moreover, the adsorption amount of nitrogen can be increased, and thus the generation of ammonia can be further promoted.

In regard to the particle diameter of the metal fine particle, the average particle diameter can be used. The average particle diameter of the titanium oxide particle is, for example, obtained by a method of directly observing the particle using an electron microscope, such as a transmission electron microscope (TEM). Specifically, the average particle diameter can be provided by an average value of particle diameters measured at ten points.

Next, the principle of generation and fixation of the ammonia using the ammonia-producing catalyst described above is explained.

For example, when the ammonia-producing catalyst is irradiated with a light in the atmosphere where nitrogen and moisture (in particular, hydrogen of the moisture) exist, the nitrogen in the atmosphere is reduced on the interface between the n-type semiconductor having the photocatalytic function and the p-type semiconductor being in contact with the n-type semiconductor, and thus the ammonia is generated. In particular, a reduction of the adsorbed water is caused by a photoproduction electron at an oxygen defected part on the surface of the n-type semiconductor (contact interface with the p-type semiconductor), and thus atomic hydrogen is formed. Further, the atomic hydrogen reduces the nitrogen molecule in the atmosphere, and thus the ammonia is generated.

On the other hand, on the surface and in the inside of the p-type semiconductor, the anion with the negative charge contained in the p-type semiconductor is disconnected (dedoped) by absorbing the irradiated light. Then, the ammonia generated at the interface where the p-type semiconductor and the n-type semiconductor contact with each other and the dedope anion bond together, and thus the ammonia salt is formed. In this way, the ammonia can be fixed and collected.

In an embodiment, an ammonia-producing catalyst includes a p-type semiconductor, an n-type semiconductor, and an ammonia-fixing compound for fixing ammonia. For example, it is configured that a titanium oxide particle as the n-type semiconductor is covered with a conductive polymer as the p-type semiconductor. In this case, an area of interface (contact area) between the n-type semiconductor and the p-type semiconductor, which serves as a reaction point of generation of ammonia, can be effectively increased. Therefore, the generation of ammonia can be further promoted.

In such a configuration, a specific surface area of the n-type semiconductor is preferably 0.1 to 1000 m²/g, and is more preferably 10 to 500 m²/g. In this case, the surface area of the n-type semiconductor can be increased, and the area of interface (contact area) with the p-type semiconductor can be increased. Thus, the generation of ammonia can be further promoted. In addition, the n-type semiconductor can be easily dispersed in the p-type semiconductor. The specific surface area is, for example, obtained by calculating from the adsorption amount of nitrogen at a liquid nitrogen temperature, i.e., the temperature from which nitrogen becomes a liquid state.

In the above configuration, in a case where a titanium oxide particle is used as the n-type semiconductor, the titanium oxide particle is preferably a nanoparticle. In this case, the surface area of the titanium oxide particle can be increased, and the area of interface (contact area) with the conductive polymer can be increased. Therefore, the generation of ammonia can be further promoted. In addition, the titanium oxide particle can be easily dispersed in the conductive polymer.

In such a case, the particle diameter (average particle diameter) of the titanium oxide particle is preferably 5 to 500 nm, and is more preferably 10 to 300 nm. The average particle diameter of the titanium oxide particle is, for example, obtained by a method of directly observing the particle using an electron microscope, such as a transmission electron microscope (TEM). Specifically, the average particle diameter can be provided by an average value of particle diameters measured at ten points.

In the above configuration, the ammonia-fixing compound may exist on an outer surface of the conductive polymer and/or on a surface of the titanium oxide particle (i.e., interface between the conductive polymer and the titanium oxide particle). The ammonia-fixing compound may exist inside of the conductive polymer.

The p-type semiconductor preferably contains an anion (counter anion) that combines with an ammonium cation (NH₄⁺). Namely, when ammonia is changed into a solid-state ammonia compound, it becomes an ammonium cation (NH₄⁺) with positive charge. In order to form the solid-state compound from the ammonium cation, the ammonium cation needs to bond with an anion with negative charge. Therefore, when the anion (counter anion) with the negative charge exists in the p-type semiconductor in addition to the ammonia-fixing compound, the ammonium cation with the positive charge and the anion with the negative charge easily form a salt. Accordingly, the fixed yield of ammonia can be further improved.

As an example of the p-type semiconductor described above, the PEDOT containing a perchlorate ion (ClO₄⁻) may be used. In this case, ClO₄⁻ contained in the PEDOT desorbs by irradiation of a light, and bonds with H⁺, to be HClO₄. Further, this HClO₄ and ammonia (NH₃) generated by the irradiation of the light bond with each other, and deposits on the surface of the PEDOT as ammonium perchlorate (NH₄ClO₄). Accordingly, fixing and collecting of the ammonia are eased, and the fixed yield of ammonia can be increased.

For example, the ammonia-fixing compound is a compound containing at least one or more ions selected from a group consisting of F⁻, Cl⁻, Br⁻, I⁻, OH⁻, COO⁻, H_{y}BOₓⁿ⁻, H_{y}CO₃ⁿ⁻, ClOₓⁿ⁻, NOₓⁿ⁻, H_{y}SOₓⁿ⁻, and H_{y}POₓⁿ⁻, in which x is any value of 1 to 5, y is any value of 0 to 3, and n is any value of 1 to 4.

Namely, when the ammonia is changed into an ammonia compound being in a solid state, it becomes an ammonium cation (NH₄⁺) with positive charge. Further, the ammonium cation needs to bond with the anion with the negative charge so as to form the solid-state compound. Therefore, when the ammonia-fixing compound contains the above described anion, the ammonia-fixing compound easily bonds with the ammonium cation. Therefore, the fixed yield of ammonia can be further improved.

For example, a substance amount ratio of the n-type semiconductor to the ammonia-fixing compound is 1:0.001-100 (i.e., n-type semiconductor:ammonia-fixing compound=1:0.001-100).

In this case, the generated ammonia can be sufficiently and securely fixed and collected while maintaining balance between an ammonia-generating capacity and an ammonia-fixing capacity. Therefore, the fixed yield of ammonia can be sufficiently increased.

In a case where the substance amount ratio of the ammonia-fixing compound to the n-type semiconductor (substance amount ratio=1) is less than 0.001 mol, the ammonia-generating capacity exceeds the ammonia-fixing capacity. Therefore, dissipation of the ammonia generated becomes large. As a result, there is a fear that the fixed yield of ammonia cannot be sufficiently increased.

On the other hand, in a case where the substance amount ratio of the ammonia-fixing compound to the n-type semiconductor (substance amount ratio=1) exceeds 100 mol, the ammonia-fixing capacity exceeds the ammonia-generating capacity. Therefore, there is a fear that the effect of increasing the fixed yield of ammonia cannot be increased any more as the ammonia generated can be sufficiently fixed and collected.

Next, the principle of generation and fixation of the ammonia using the ammonia-producing catalyst described above will be explained.

For example, when the ammonia-producing catalyst is irradiated with a light in the atmosphere where nitrogen and moisture (in particular, hydrogen of the moisture) exist, the nitrogen in the atmosphere is reduced on the interface between the n-type semiconductor having the photocatalytic function and the p-type semiconductor being in contact with the n-type semiconductor, and thus the ammonia is generated. In particular, a reduction of the adsorbed water is caused by a photoproduction electron at an oxygen defected part on the surface of the n-type semiconductor (contact interface with the p-type semiconductor), and thus atomic hydrogen is formed. Further, the atomic hydrogen reduces the nitrogen molecule in the atmosphere, and thus the ammonia is generated.

The ammonia generated on the interface where the p-type semiconductor and the n-type semiconductor contact with each other is fixed and collected as the solid-state ammonium compound by the ammonia-fixing compound.

Moreover, on the surface and in the inside of the p-type semiconductor, the anion with the negative charge contained in the p-type semiconductor is disconnected (dedoped) by absorbing the irradiated light. Then, the ammonia generated at the interface where the p-type semiconductor and the n-type semiconductor contact with each other and the dedoped anion bond together, and thus the ammonia salt is formed. Also in this way, the ammonia can be fixed and collected.

### EXAMPLES

### Example 1

Next, examples of the ammonia-producing catalysts, which includes a metal fine particle with the nitrogen adsorption function, and a comparative example to the ammonia-producing catalysts of the example 1 will be described.

In the example 1, as samples S111, S112, S121 to S126, ammonia-producing catalysts each including the metal fine particle with the nitrogen adsorption function are prepared. Also, as a comparative sample C1, an ammonia-producing catalyst of the comparative example without including a metal fine particle is prepared. Further, the fixed amount of ammonia obtained in each of the samples is evaluated.

The ammonia-producing catalyst of the comparative example (comparative sample C1) is the same as the ammonia-producing catalysts of the examples (samples S111, S112, S121 to S126) on the point of the basic structure and its manufacturing method, except that the ammonia-producing catalyst of the comparative example C1 does not include the metal fine particle with the nitrogen adsorption function. Therefore, descriptions of the basic structure and the manufacturing method of the comparative sample C1 will be omitted.

First, the ammonia-producing catalyst of the example 1 will be described with reference to the drawings.

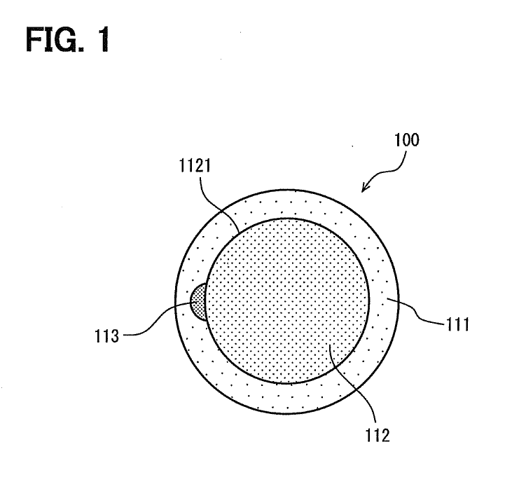

As shown in FIG. 1, an ammonia-producing catalyst 100 includes a p-type semiconductor (conductive polymer) 111, an n-type semiconductor (titanium oxide (TiO₂) particle) 112, and a metal fine particle 113 having a function of adsorbing nitrogen. FIG. 1 is a diagram schematically illustrating the ammonia-producing catalyst 100.

Hereinafter, the ammonia-producing catalyst 100 will be described more in detail.

As shown in FIG. 1, the ammonia-producing catalyst 100 includes a titanium oxide particle 112 having the photocatalytic function and a conductive polymer 111 covering the titanium oxide particle 112. The particle diameter (average particle diameter) of the titanium oxide particle 112 is 20 nm. As the conductive polymer 111, poly (3,4-ethylenedioxythiophene) (PEDOT) is used. The PEDOT contains a perchlorate ion (ClO₄⁻), which serves as an anion (counter anion) bonded with an ammonium cation (NH₄⁺).

As shown in FIG. 1, the metal fine particle 113 having the nitrogen adsorption function exists on the surface 1121 of the titanium oxide particle 112. Namely, the metal fine particle 113 is in the state of being in contact with the titanium oxide particle 112. The metal fine particle 113 exists on the interface (contact interface) where the titanium oxide particle 112 and the conductive polymer 111 contact with each other. The particle diameter (average particle diameter) of the metal fine particle 113 is 1 nm.

In the example 1, the metal fine particle 113 of the samples S111, S121 is rhodium (Rh). The metal fine particle 113 of the samples S112, S122 is palladium (Pd). The metal fine particle 113 of the sample S123 is ruthenium (Ru). The metal fine particle 113 of the sample S124 is silver (Ag). The metal fine particle 113 of the sample S125 is platinum (Pt). The metal fine particle 113 of the sample S126 is iron (Fe).

Next, the method of manufacturing the ammonia-producing catalyst will be described.

Firstly, in a beaker, 0.25 g of titanium oxide (TiO₂) particle (e.g., AEROXIDE (registered trademark) TiO₂ P25 made by NIPPON AEROSIL CO., LTD) is solved in a mixed solvent of 40 ml of pure water and 10 ml of ethanol. Further, a metal raw material as a raw material of the metal fine particle (i.e., Rh, Pd, Ru, Ag, Pt, or Fe) with the nitrogen adsorption function is added to the solution and mixed to be solved in the solution. In this case, the metal raw material is added at a predetermined amount so that the metal raw material is included at a predetermined concentration relative to the titanium oxide particle.

In the example 1, the metal raw material of the samples S111, S121 is RhCl₃.3H₂O. The metal raw material of the samples S112, S122 is Pd(NO₃)₃. The metal raw material of the sample S123 is Ru(NO₃)₃. The metal raw material of the sample S124 is Ag₂O. The metal raw material of the sample S125 is H₂PtCl₆. The metal raw material of the sample S126 is Fe(NO₃)₃.9H₂O.

In the samples S111, S112, the molar ratio (substance amount ratio) of the titanium oxide particle to the metal fine particle is 100:0.1 (i.e., the metal fine particle is added at 0.1 mol % relative to the titanium oxide particle). In the samples S121 to S126, the molar ratio (substance amount ratio) of the titanium oxide particle to the metal fine particle is 100:0.5 (i.e., the metal fine particle is added at 0.5 mol % relative to the titanium oxide particle).

Next, while agitating the mixed solvent in the beaker, a xenon lamp (e.g., PU-21 with a wavelength of 250 to 400 nm made by TOPCON TECHNOHOUSE CORPORATION) is irradiated from the top of the beaker for 3 hours so as to deposit the metal fine particle (Rh, Pd, Ru, Ag, Pt, or Fe) on the surface of the titanium oxide particle by a photodeposition reaction. Then, the mixed solvent is dried at 80 degrees Celsius (° C.). As a result, the titanium oxide particle 112 in a state where the metal fine particle (Rh, Pd, Ru, Ag, Pt, or Fe) is deposited on the surface is obtained.

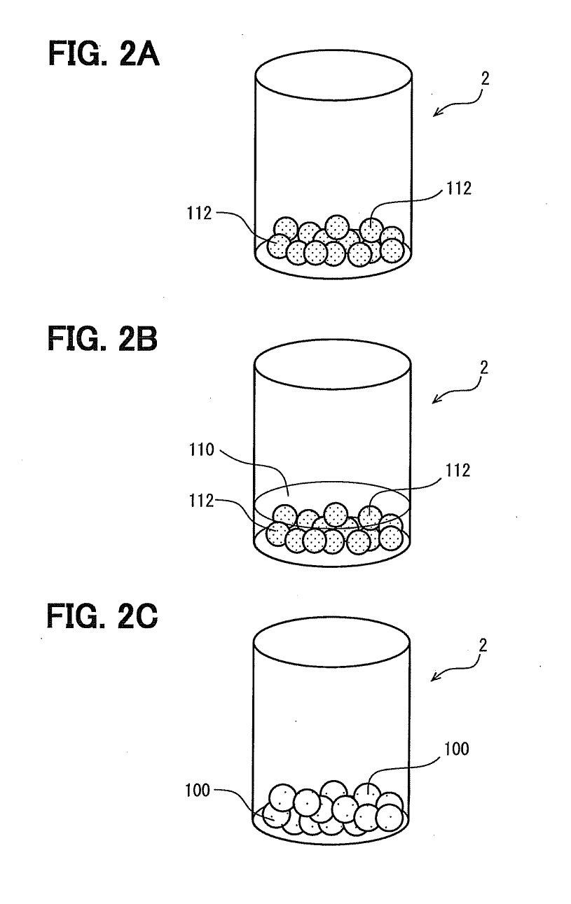

Next, as shown in FIG. 2A, 10 mg of the titanium oxide particle 112 on which surface the metal fine particle (not shown) is deposited is weighted in a sample bottle 2 with the size of 5 cc.

Thereafter, as shown in FIG. 2B, 100 mg of poly (3,4-ethylenedioxythiophene)-block-polyethylene glycol 110 (e.g., nitromethane dispersion liquid made by Sigma-Aldrich Co. LLC.) is added to the sample bottle 2, and agitated and mixed. This mixture is heated for 1 hour at 80° C. to remove nitromethane from the mixture and dry the mixture.

Thus, as shown in FIG. 2C, the samples S111, S112, S121 to S126 of the ammonia-producing catalyst 100, in each of which the titanium oxide particle and the metal fine particle on the surface of the titanium oxide particle are covered with the conductive polymer, are obtained.

Next, evaluation of the fixed amount of ammonia in the ammonia-producing catalyst 100 will be described.

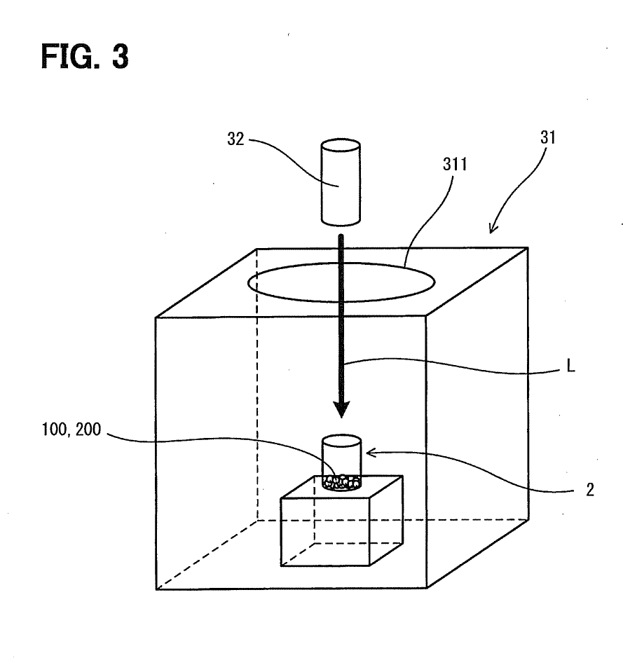

As shown in FIG. 3, the sample bottle 2 containing the ammonia-producing catalyst 100 is placed in an acrylic container 31 having a quartz window 311 on a top wall. In this case, it is set such that an irradiation area (exposure area) of a light L of an artificial solar lamp 32 is approximately 2 cm². The relative humidity inside of the acrylic container 31 is regulated to approximately 70% using a humidity controlling agent. Also, the temperature and the pressure inside of the acrylic container 31 is a normal temperature and a normal pressure.

Next, as shown in FIG. 3, the light L is irradiated to the sample of the ammonia-producing catalyst 100 using the artificial solar lamp 32 (e.g., 100 W of XC-100BF1RC made by SERIC Ltd.). The light L from the artificial solar lamp 32 is adjusted to the intensity of 260 W/m², and is irradiated to the sample of the ammonia-producing catalyst 100 through the quartz window 311 of the acrylic container 31. In this case, the irradiation time is 1 week.

Next, 5 ml of distilled water is added to the sample of the ammonia-producing catalyst 100 so as to dissolve the ammonia generated and fixed into ammonium ion in the water. Thus, an ammonium aqueous solution is obtained. Then, the concentration of the ammonium ion contained in the ammonium aqueous solution is detected using an ion chromatograph (e.g., ICS-1500, column CS16 made by Japan Dionex Corporation). The detected concentration is evaluated as the fixed amount of ammonia.

In the example 1, the fixed amount of ammonia obtained by the ammonia-producing catalyst of the comparative example (comparative sample C1) is defined to 1 as a reference. The fixed amount of ammonia of the ammonia-producing catalyst 100 of each of the samples S111, S112, S121 to S126 is calculated.

Next, the principle of generation and fixation of the ammonia using the ammonia-producing catalyst will be briefly explained.

In the example 1, when the ammonia-producing catalyst is irradiated with the light in the atmosphere where nitrogen and moisture (in particular, hydrogen of the moisture) exist, the nitrogen in the atmosphere is reduced on the interface between the titanium oxide particle having the photocatalytic function and the conductive polymer being in contact with the titanium oxide particle, and thus the ammonia is generated. In particular, the reduction of the adsorbed water is caused by a photoproduction electron at an oxygen defected part on the surface of the titanium oxide particle (contact interface with the conductive polymer), and thus atomic hydrogen is formed. Further, the atomic hydrogen reduces the nitrogen molecule in the air, and thus the ammonia is generated.

On the other hand, on the surface and in the inside of the conductive polymer, the anion with the negative charge contained in the conductive polymer is disconnected (dedoped) by absorbing the irradiated light. In this case, perchlorate ion (ClO₄⁻) is dedoped, and is bonded with a hydrogen ion (H⁺) to be HClO₄. Further, the ammonia (NH₃) generated is bonded with the HClO₄, so ammonium perchlorate (NH₄ClO₄) is deposited on the surface of the conductive polymer. In this way, the ammonia can be fixed and collected.

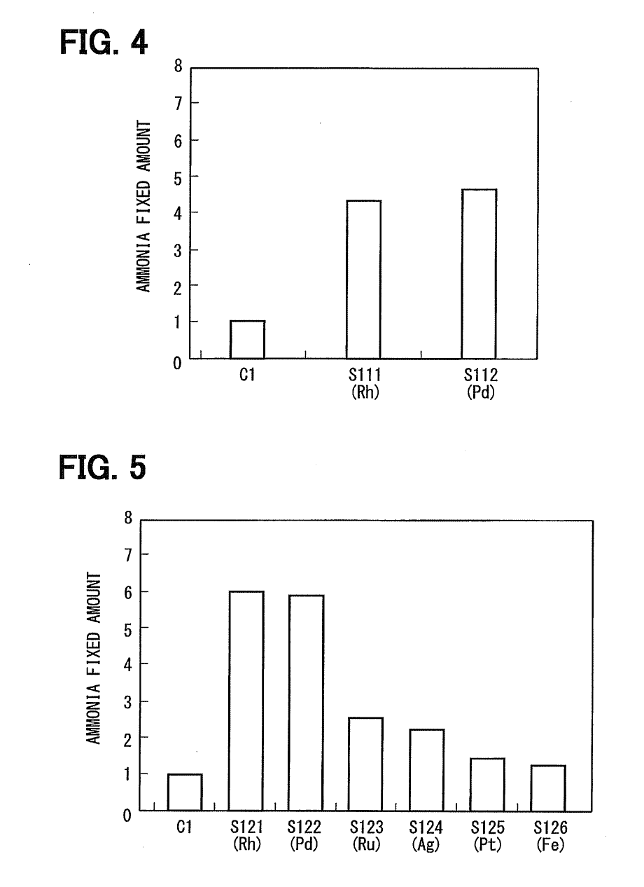

FIG. 4 and FIG. 5 are graphs illustrating the evaluation results of the fixed amount of ammonia.

FIG. 4 is a graph illustrating the fixed amount of ammonia of the ammonia-producing catalysts of the samples S111, S112 in which the added ratio of the metal fine particle relative to the titanium oxide particle is 0.1 mol %.

FIG. 5 is a graph illustrating the fixed amount of ammonia of the ammonia-producing catalysts of the samples S121 to S126 in which the added ratio of the metal fine particle relative to the titanium oxide particle is 0.5 mol %.

As shown in FIG. 4 and FIG. 5, it is appreciated that the fixed amount of ammonia of the ammonia-producing catalysts of the samples S111, S112, S121 to S126 is greater than that of the ammonia-producing catalyst of the comparative sample C1 without including the metal fine particle with the nitrogen adsorption function. Namely, in the ammonia-producing catalysts of the samples S111, S112, S121 to S126, the generation of ammonia is promoted as having the metal fine particles with the nitrogen adsorption function. Thus, the generated amount of ammonia is increased, resulting in the increase in the fixed amount of ammonia.

In addition, as comparing the samples including the same kind of the metal fine particle, such as the sample S111 and the sample S121, and the sample S112 and the sample S122, it is appreciated that the fixed amount of ammonia increases with an increase in the added ratio of the fine metal particle relative to the titanium oxide particle. Namely, the fixed amount of ammonia of the ammonia-producing catalyst of the samples S121, S122 in which the added ratio of the metal fine particle relative to the titanium oxide particle is 0.5 mol % is greater than that of the ammonia-producing catalyst of the samples S111, S112 in which the added ratio of the metal fine particle relative to the titanium oxide particle is 0.1 mol %. In this way, the generation of ammonia is promoted with the increase in the added ratio of the metal fine particle relative to the titanium oxide particle. Further, the fixed amount of ammonia is increased in the increase in the generation amount of ammonia.

Based on the results described above, it is appreciated that the generation of ammonia of the ammonia-producing catalyst is promoted by adding the metal fine particle with the nitrogen adsorption function, and thus the generated amount of ammonia can be sufficiently increased.

Next, evaluation of the fixed amount of ammonia of the ammonia-producing catalyst based on the difference of the particle diameter (average particle diameter) of the metal fine particle will be described.

In this evaluation, as samples S131 to S133, S141 to S143, S151 to S153, S161 to S163, multiple ammonia-producing catalysts including the metal fine particles with different particle diameters are prepared, and the fixed amount of ammonia of each of the ammonia-producing catalysts is evaluated.

The metal fine particle of the samples S131 to S133, S141 to S143 is rhodium (Rh). The metal fine particle of the samples S151 to S153, S161 to S163 is palladium (Pd).

In the samples S131 to S133, S151 to S153, the added ratio of the metal fine particle relative to the titanium oxide particle is 0.1 mol %. In the samples S141 to S143, S161 to S163, the added ratio of the metal fine particle relative to the titanium oxide particle is 0.5 mol %.

The sample S131 is produced by the similar method to the samples S111, S112, S121 to S126. However, in place of the photodeposition reaction, after the mixed solvent is dried at 80° C., heat treatment is performed at 500° C. and for 2 hours in the atmosphere of air to deposit the metal fine particle on the surface of the titanium oxide particle. The samples S141, S151, S161 are produced by the similar method. The sample S132 is produced by the similar method to the samples S111, S112, S121 to S126. However, in place of the photodeposition reaction, after the mixed solvent is dried at 80° C., heat treatment is performed at 500° C. and for 2 hours in an atmosphere of 4% of H₂/N₂ to deposit the metal fine particle on the surface of the titanium oxide particle. The samples S142, S152, S162 are produced by the similar method.

The sample S133 is produced by the same method as the samples S111, S112, S121 to S126. The samples S143, S153, S163 are produced by the same method.

The particle diameter (average particle diameter) of the metal fine particle of the sample S131 is 6.2 nm. The particle diameter (average particle diameter) of the metal fine particle of the sample S132 is 8.4 nm. The particle diameter (average particle diameter) of the metal fine particle of the sample S133 is 0.8 nm.

The particle diameter (average particle diameter) of the metal fine particle of the sample S141 is 8.3 nm. The particle diameter (average particle diameter) of the metal fine particle of the sample S142 is 12.2 nm. The particle diameter (average particle diameter) of the metal fine particle of the sample S143 is 1 nm.

The particle diameter (average particle diameter) of the metal fine particle of the sample S151 is 7.4 nm. The particle diameter (average particle diameter) of the metal fine particle of the sample S152 is 8.9 nm. The particle diameter (average particle diameter) of the metal fine particle of the sample S153 is 0.9 nm.

The particle diameter (average particle diameter) of the metal fine particle of the sample S161 is 10.1 nm. The particle diameter (average particle diameter) of the metal fine particle of the sample S162 is 15.2 nm. The particle diameter (average particle diameter) of the metal fine particle of the sample S163 is 1 nm.

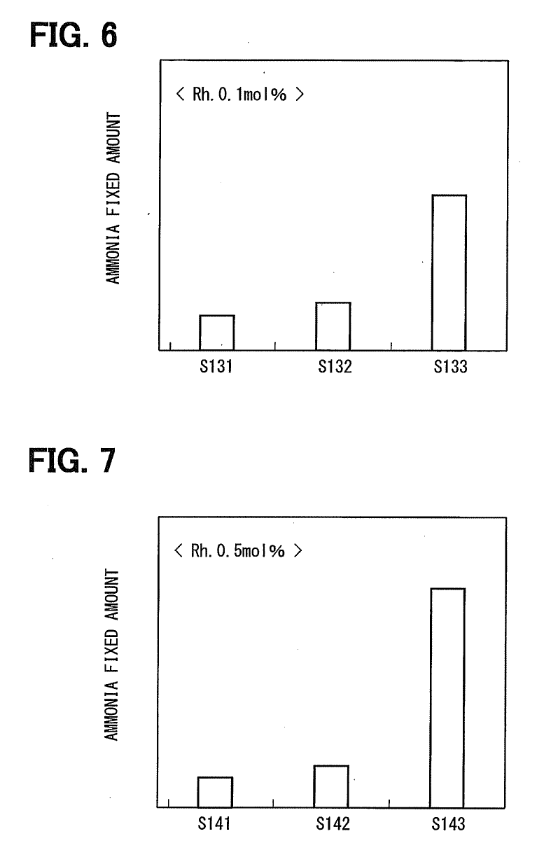

FIGS. 6 to 9 are graphs illustrating evaluation results of the fixed amount of ammonia.

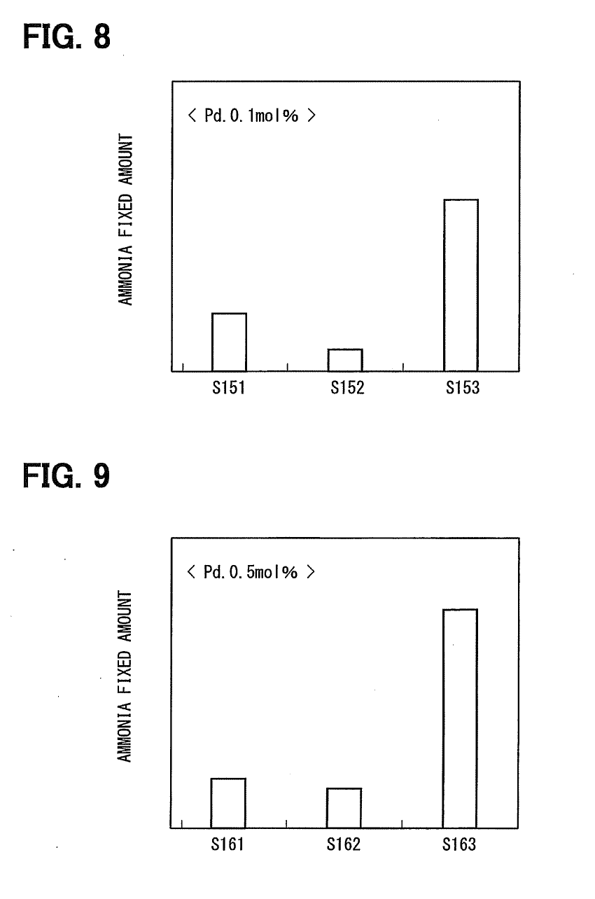

FIG. 6 is a graph illustrating the fixed amount of ammonia of the samples S131 to S133. FIG. 7 is a graph illustrating the fixed amount of ammonia of the samples S141 to S143. FIG. 7 is a graph illustrating the fixed amount of ammonia of the samples S151 to S153. FIG. 8 is a graph illustrating the fixed amount of ammonia of the samples S161 to S163.

As shown in FIG. 6, the fixed amount of ammonia of the samples S131, S132 in which the particle diameter of the metal fine particle exceeds 5 nm is much smaller than that of the sample S133 in which the particle diameter of the metal fine particle is 5 nm or less. The similar results are also found in the other samples S141 to S143, S151 to S153, and S161 to S163, as shown in FIGS. 7 to 9.

Based on the above results, it is appreciated that the effect of including the metal fine particle in the ammonia-producing catalyst, that is, the effect of promoting the generation of ammonia and sufficiently increasing the generated amount of the ammonia further improves when the particle diameter of the metal fine particle is 5 nm or less.

### Example 2

Next, examples of the ammonia-producing catalysts, which includes the ammonia-fixing compound, and a comparative example to the ammonia-producing catalysts of the example 2 will be described.

In the example 2, as samples S211 to S213, ammonia-producing catalysts of the examples each including the ammonia-fixing compound are prepared. Also, as a comparative sample C2, an ammonia-producing catalyst of the comparative sample without including the ammonia-fixing compound is prepared. Further, the fixed amount of ammonia obtained in each of the samples is evaluated.

The ammonia-producing catalyst of the comparative example (comparative sample C2) is the same as the ammonia-producing catalyst of the examples (samples S211 to S213) on the point of the basic structure and its manufacturing method, but is different from the ammonia-producing catalyst of the examples as it does not include the ammonia-fixing compound. Therefore, descriptions of the basic structure and the manufacturing method of the comparative sample C2 will be omitted.

First, the ammonia-producing catalyst of the examples will be described with reference to the drawings.

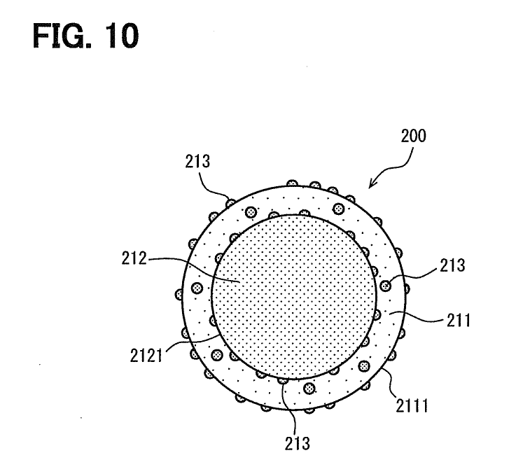

As shown in FIG. 10, an ammonia-producing catalyst 200 includes a p-type semiconductor (conductive polymer) 211, an an-type semiconductor (titanium oxide (TiO₂) particle) 212, and an ammonia-fixing compound 213 for fixing ammonia. FIG. 10 is a diagram schematically illustrating the ammonia-producing catalyst 200.

Hereinafter, the ammonia-producing catalyst 200 will be described more in detail.

As shown in FIG. 10, the ammonia-producing catalyst 200 includes a titanium oxide particle 212 having a photocatalytic function, and a conductive polymer 211 covering the titanium oxide particle 212. The particle diameter (average particle diameter) of the titanium oxide particle 212 is 21 nm. The conductive polymer 211 is poly (3,4-ethylenedioxythiophene) (PEDOT). The PEDOT contains a perchlorate ion (ClO₄⁻), which serves as an anion (counter anion) bonded with an ammonium cation (NH₄⁺). The perchlorate ion (ClO₄⁻) contained in the PEDOT has a function of fixing ammonia, similar to an ammonia-fixing compound 213, which will be described later.

As shown in FIG. 10, the ammonia-fixing compound 213 partly exists on an outer surface 2111 of the conductive polymer 211 and/or a surface 2121 of the titanium oxide particle 212 (i.e., interface between the conductive polymer 211 and the titanium oxide particle 212). The ammonia-fixing compound 213 also exists inside of the conductive polymer 211. The substance amount ratio (molar ratio) of the titanium oxide particle 212 to the ammonia-fixing compound 213 is 1:0.001-100 (i.e., titanium oxide particle 212:ammonia-fixing compound 213=1:0.001 to 100).

In the example 2, the ammonia-fixing compound 213 of the sample S211 includes ClO₄⁻. The ammonia-fixing compound 213 of the sample S212 includes Cl⁻. The ammonia-fixing compound 213 of the sample S213 includes H₂PO₃⁻. The molar ratio of the titanium oxide particle 212 to the ammonia-fixing compound 213 is 1:4 (i.e., titanium oxide particle 212:ammonia-fixing compound 213=1:4).

Next, a method of manufacturing the ammonia-producing catalyst will be described.

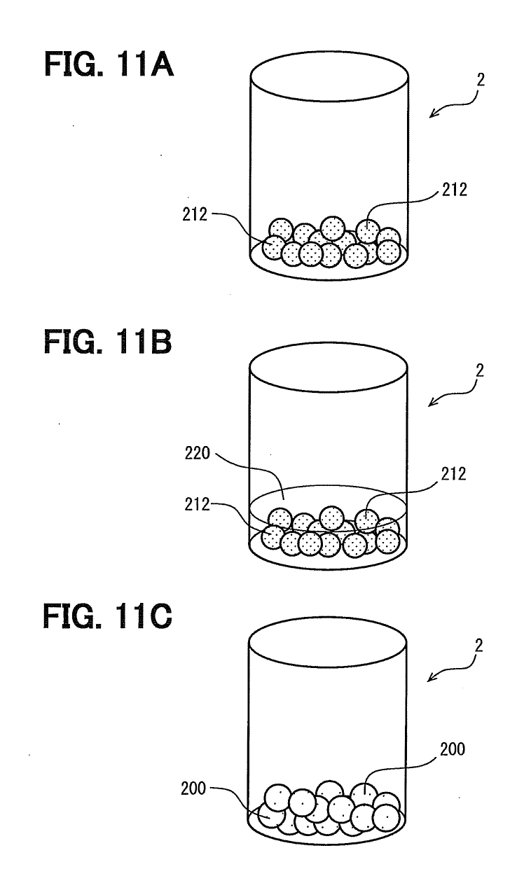

First, as shown in FIG. 11A, in a sample bottle 2 with the size of 5 cc, 10 mg of titanium oxide particle 212 (e.g., AEROXIDE (registered trademark) TiO₂ P25 made by NIPPON AEROSIL CO., LTD) is weighted.

Next, as shown in FIG. 11B, 100 mg of poly (3,4-ethylenedioxythiophene)-block-polyethylene glycol (e.g., nitromethane dispersion liquid made by Sigma-Aldrich Co. LLC.) 220 is added to the sample bottle 2, and agitated and mixed. Further, 0.05 mmol of the ammonia-fixing compound (e.g., ClO₄⁻, Cl⁻, or H₂PO₃⁻, made by Wako Pure Chemical Industries Ltd.) is added to the sample bottle 2, and agitated and mixed. Then, this mixture is heated for 1 hour at 80° C. to remove nitromethane from the mixture and dry the mixture. Thus, the ammonia-producing catalyst 200 is obtained, as shown in FIG. 11C.

Next, evaluation of the fixed amount of ammonia of the ammonia-producing catalyst will be described.

As shown in FIG. 3, the sample bottle 2 containing the sample of the ammonia-producing catalyst 200 is placed in the acrylic container 31 having the quartz window 311 on a top wall. In this case, it is set such that an irradiation area (exposure area) of a light L of an artificial solar lamp 32 is approximately 2 cm². The relative humidity inside of the acrylic container 31 is regulated to approximately 70% using a humidity controlling agent. Also, the temperature and the pressure inside of the acrylic container 31 is a normal temperature and a normal pressure.

Next, as shown in FIG. 3, the light L is irradiated to the sample of the ammonia-producing catalyst 200 using the artificial solar lamp 32 (e.g., 100 W, XC-100BF1RC made by SERIC Ltd.). The light L from the artificial solar lamp 32 is adjusted to the intensity of 260 W/m², and is irradiated to the sample of the ammonia-producing catalyst 200 through the quartz window 311 of the acrylic container 31. In this case, the irradiation time is 1 week.

Next, 5 ml of distilled water is added to the sample of the ammonia-producing catalyst 200 to dissolve the ammonia generated and fixed into ammonium ion in the water. Thus, an ammonium aqueous solution is obtained. Then, the concentration of the ammonium ion contained in the ammonium aqueous solution is detected using an ion chromatograph (e.g., ICS-1500, column CS16 made by Japan Dionex Corporation). The detected concentration is evaluated as the fixed amount of ammonia.

In this case, the fixed amount of ammonia obtained by the ammonia-producing catalyst of the comparative example (comparative sample C2) is defined to 1 as a reference. The fixed amount of ammonia of the ammonia-producing catalyst 200 of each of the examples (samples S211 to S213) is calculated.

Next, the principle of generation and fixation of the ammonia using the ammonia-producing catalyst is briefly explained.

In the example 2, when the ammonia-producing catalyst is irradiated with the light in the atmosphere where nitrogen and moisture (in particular, hydrogen of the moisture) exist, the nitrogen in the atmosphere is reduced on the interface between the titanium oxide particle having the photocatalytic function and the conductive polymer being in contact with the titanium oxide particle, and thus the ammonia is generated. In particular, a reduction of the adsorbed water is caused by a photoproduction electron at an oxygen defected part on the surface of the titanium oxide particle (contact interface with the conductive polymer), and thus atomic hydrogen is formed. Further, the atomic hydrogen reduces the nitrogen molecule in the air, and thus the ammonia is generated.

The ammonia (NH₃) generated on the interface where the conductive polymer and the titanium oxide particle contact with each other bond with the ammonia-fixing compound (ClO₄⁻, Cl⁻, H₂PO₃⁻) contained in the ammonia-producing catalyst. Thus, the ammonia is fixed and collected as a solid-state ammonia compound (NH₄ClO₄, NH₄Cl, NH₄H₂PO₄).

Further, on the surface and in the inside of the conductive polymer, the anion with the negative charge contained in the conductive polymer is disconnected (dedoped) by absorbing the irradiated light. In this case, perchlorate ion (ClO₄⁻) is dedoped, and bonded with a hydrogen ion (H⁺) to be HClO₄. Further, the ammonia (NH₃) generated is bonded with the HClO₄, so ammonium perchlorate (NH₄ClO₄) is deposited on the surface of the conductive polymer. Therefore, the ammonia can be fixed and collected.

Next, the evaluation result of the fixed amount of ammonia will be described.

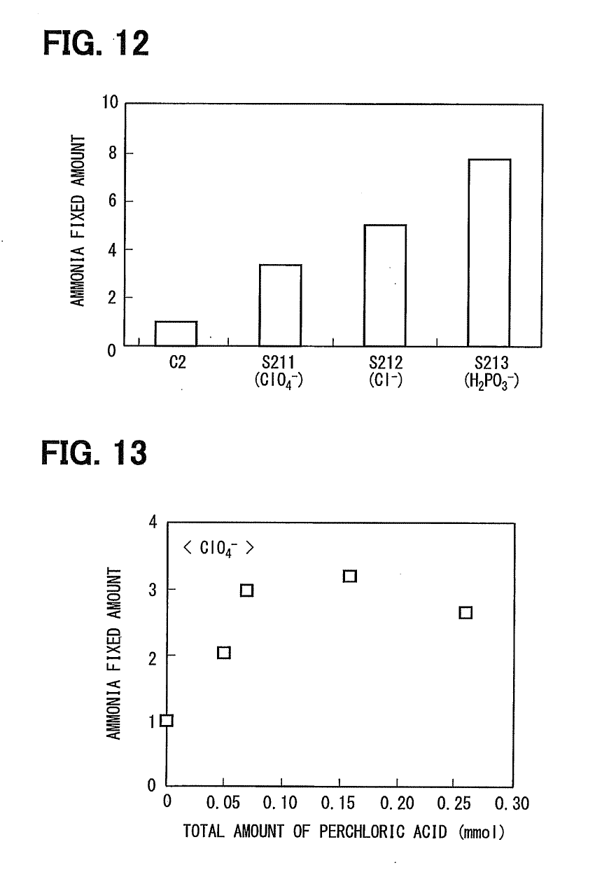

FIG. 12 is a graph illustrating the fixed amount of ammonia of the ammonia-producing catalysts of the samples S211 to S213 each including the ammonia-fixing compound.

As shown in FIG. 12, it is appreciated that the fixed amount of ammonia of the ammonia-producing catalysts of the samples S211 to S213 including the ammonia-fixing compound are much greater than that of the ammonia-producing catalyst of the comparative sample C2 without including the ammonia-fixing compound. In particular, the fixed amount of the sample S211 is approximately three times of the comparative sample C2. The fixed amount of the sample S212 is approximately five times of the comparative example C2. The fixed amount of the sample S213 is approximately eight times of the comparative example C2.

FIG. 13 is a graph illustrating the fixed amount of ammonia of the ammonia-producing catalyst using ClO₄⁻ as the ammonia-fixing compound. In FIG. 13, the horizontal axis represents the total amount (mmol) of the perchloric acid. The vertical axis represents the fixed amount of ammonia, in which the fixed amount of ammonia in the ammonia-producing catalyst without including ClO₄⁻ as the ammonia-fixing compound is defined as 1. In such a case, however, a slight amount (0.0008 mmol) of the perchlorate ion (ClO₄⁻) is contained in the conductive polymer (PEDOT).

According to FIG. 13, it is appreciated that the fixed amount of ammonia increases with an increase in the added amount of ClO₄⁻. Namely, the effect is sufficiently achieved by adding the ammonia-fixing compound.

Based on the results described above, it is appreciated that the fixed yield of ammonia can be sufficiently increased by adding the ammonia-fixing compound for fixing ammonia in the ammonia-producing catalysts of the examples.

While only the selected exemplary embodiment and examples have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiment and examples according to the present disclosure is provided for illustration only, and not for the purpose of limiting the disclosure as defined by the appended claims and their equivalents.

What is claimed is:

1. An ammonia-producing catalyst comprising:
a p-type semiconductor;
an n-type semiconductor; and
a metal fine particle having a function of adsorbing nitrogen.

2. The ammonia-producing catalyst according to claim 1, wherein
the metal fine particle is made of one or more selected from a group consisting of Fe, Rh, Pd, Ru, Pt, Ag, Ni, Cu, Au, Co, and Ir.

3. The ammonia-producing catalyst according to claim 1, wherein
a ratio of the metal fine particle to the n-type semiconductor is 5 mol % or less of the n-type semiconductor.

4. The ammonia-producing catalyst according to claim 1, wherein
the metal fine particle has a particle diameter of 5 nm or less.

5. An ammonia-producing catalyst comprising:
a p-type semiconductor;
an n-type semiconductor; and
an ammonia-fixing compound for fixing ammonia.

6. The ammonia-producing catalyst according to claim 1, wherein
the ammonia-fixing compound is a compound containing one or more ions selected from a group consisting of F⁻, Cl⁻, Br⁻, I⁻, OH⁻, COO⁻, H_{y}BOₓⁿ⁻, H_{y}CO₃ⁿ⁻, ClOₓⁿ⁻, NOₓⁿ⁻, H_{y}SOₓⁿ⁻, and H_{y}POₓⁿ⁻, in which x is any value of 1 to 5, y is any value of 0 to 3, and n is any value of 1 to 4.

7. The ammonia-producing catalyst according to claim 1, wherein
a molar ratio of the n-type semiconductor to the ammonia-fixing compound is 1:0.001-100.
